(19) United States
(12) Patent Application Publication
(10) Pub. No.: US 2009/0046110 A1
(43) Pub. Date: Feb. 19, 2009

(54) METHOD AND APPARATUS FOR MANIPULATING A DISPLAYED IMAGE

(75) Inventors: Daniel J. Sadler, Gilbert, AZ (US); Pawitter J.S. Mangat, Gilbert, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/839,610

(22) Filed: Aug. 16, 2007

(51) Int. Cl. G09G 5/00; G06F 3/041

(52) U.S. Cl. 345/660; 345/173

(57) ABSTRACT

A method and an apparatus are for manipulating an image displayed on a display of an electronic device (100). Functions that are used include panning the image in a direction that is determined in response to a detection of a first stroke (125, 410, 610) of a touch and pressure sensitive input modality (105) which is performed using an amount of touch pressure that meets a first pressure criterion, while the electronic device is in a pan mode; changing between the pan mode and a zoom mode in response to a touch pressure of the input modality that meets a second pressure criterion; and zooming the image in response to a second stroke (130, 415, 615) of the input modality, wherein the stroke is performed using an amount of touch pressure that meets a third pressure criterion, while the electronic device is in the zoom mode.

### FIELD OF THE INVENTION

The present invention relates generally to electronic devices and more particularly to the manipulation of images displayed by electronic devices.

### BACKGROUND

Electronic devices that have touch sensitive input modalities are known. One example is the MOTOMing™ cellular telephone device distributed by Motorola, Inc. Another is the iPhone distributed by Apple, Inc. Electronic devices that provide pan and zoom controlled viewing for the manipulation of maps, other documents, and other images are known. Google™ Earth as used in a PC is one example. The Q phone distributed by Motorola, Inc. is another example. A convenient method of switching between a pan mode and a zoom mode for presenting the maps is a desirable feature. Methods used in current electronic devices are not typically very convenient.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIGS. 1, 4 and 6 are diagrams that show an electronic device, in accordance with certain embodiments;

FIG. 2 is a functional block diagram showing some aspects of the electronic device 100, in accordance with certain embodiments

FIGS. 3, 5, and 7 show time plots that are examples of certain characteristics of strokes depicted, respectively, in FIGS. 1, 4 and 6, in accordance with certain embodiments; and

FIGS. 8 and 9 are flow charts that show some steps of a method for manipulating an image displayed on a display of an electronic device, in accordance with certain embodiments.

FIGS. 10 and 11 are diagrams that show two views of an electronic device 1000, in accordance with certain embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to touchscreen input modalities. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Generally, the embodiments described in more detail below provide a method and apparatus for manipulating an image displayed on a display of an electronic device using a touch sensitive input modality that has a capability of sensing touch position and touch pressure. The embodiments provide a benefit of being able to switch between a pan and a zoom mode without being constrained to use a button (either a hard switch) or a soft (virtual) button. The embodiments include embodiments in which the input modality is a morphing surface that changes configurations according to differing modes, such as morphing between a cell phone key pad, camera controls, text messaging, and, media (sound or video) control configurations.

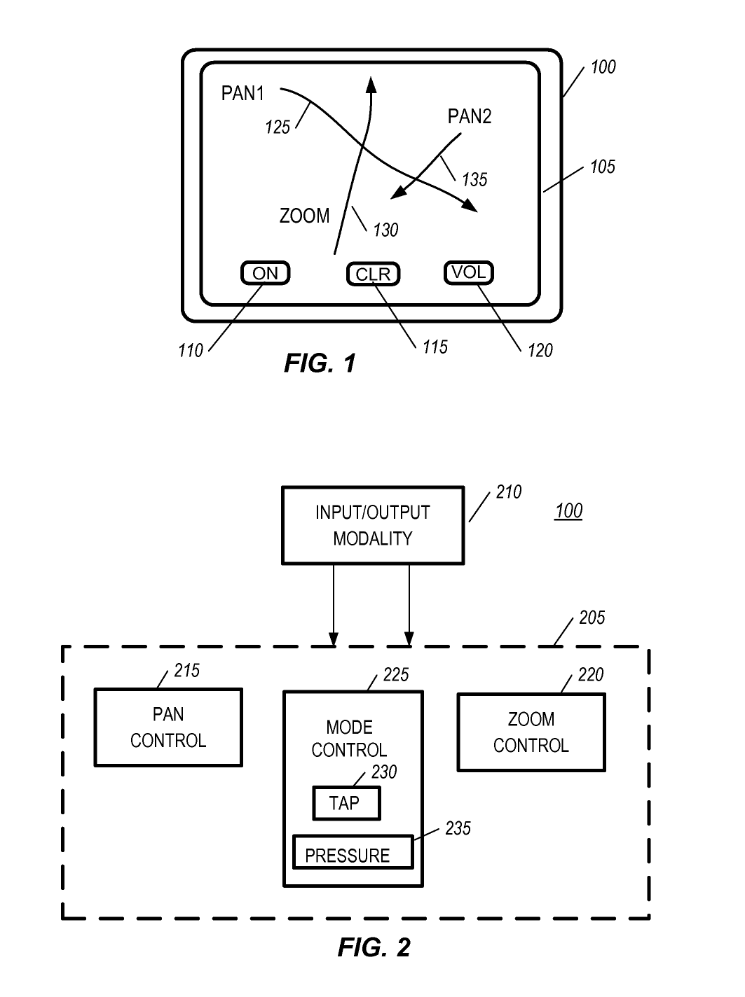

Referring to FIG. 1, a diagram shows an electronic device 100, in accordance with certain embodiments. The electronic device 100 comprises a touch screen 105. The electronic device may be any electronic device having a touch screen. A few examples are cellular telephones, remote controls, console stations, computers, and electronic games. In these embodiments, the touch screen 105 is capable of operating as an input modality for sensing touch position and at least two touch pressure levels. The touch screen 105 may use conventional techniques to sense touch position and touch pressure. The touch screen is also capable of displaying images, which may include maps, and may superimpose active objects over an image that otherwise fills an image region (display region) of the input/output modality. An example of such an active object is a button. In other embodiments, the input portion of the input/output modality may be physically or virtually separate from the image portion. An example of this is shown in FIGS. 10-11.

The touch screen 105 may be of the type that senses touch position in manner that depends on no moving parts, or substantially no moving parts. The technique used for sensing touch position may be, for example, one that uses conventional optical, capacitive, or resistive techniques. Newly developed techniques may alternatively be used. The technique for sensing touch position typically allows determination of an x-y position of a tool, which may also be called a stroke tool, that is touching a physical surface of the touch screen 105 or is very close to making contact with the surface of the touch screen 105. When the stroke tool is moved, then it may be said that a stroke is detected. The use of the term “stroke” tool does not preclude its use to perform a “tap” or exert constant pressure input at one x-y position on the touch screen 105. The touch position sensing technique, in addition to providing an x-y position of the stroke tool, may also provide a definitive “touching” state indication that has a first binary state (F) that indicates when the stroke tool is not considered to be touching (or very close to touching) the surface of the touch screen 105 (the no-touch state), and a second binary state (T) when it is providing position information (the touch state). The stroke tool may be one of many implements, such as a pen, pencil, pointer, stick, or a person's digit.

The touch screen 105 may be of the type that senses touch pressure in manner that depends on no moving parts, or substantially no moving parts. The technique used for sensing touch pressure may be, for example, one that uses conventional force sensing resistive or strain gauge techniques. Newly developed techniques may alternatively be used. The technique for sensing touch pressure typically allows determination of an “analog” value that is related to a pressure exerted by the stroke tool on a physical surface of the touch screen 105. “Analog” is in quotes since in typical embodiments, analog values are converted to digital values that represent the analog input value. The touch pressure sensing technique may provide a lowest pressure state indication in a situation when the input pressure is less than a threshold value. This could be termed a “no pressure” or “zero pressure” state.

Above the “no pressure state”, the input modality may provide a digitized analog pressure value for the amount of touch pressure exerted by the stroke tool, or may provide quantized pressure values—as few as two, including the “no pressure” value.

The characterization of essentially no moving parts for the touch position and touch pressure sensing aspects of the touch screen 105 is meant to include small inevitable movements of surfaces of the touch screen 105 that may occur in multilayer displays when touch pressure is applied using a stroke tool, especially if high pressure is applied. It should be noted that the pressure sensing and touch sensing may, in some embodiments, use the same technology, but in others may be completely independent. Further, there may be situations (when the touch pressure is below a threshold) in which a no pressure output is indicated while a touch position is reliably indicated.

Referring again to FIG. 1, three “soft” buttons 110, 115, 120 and three strokes 125, 130, 135 are shown on the touch screen 105. One may imagine that a map (not shown) is being displayed on the touch screen 105. The “soft” buttons 110, 115, 120, when they are active, may be used to control the 100 when it shows them on the touch screen 105. The strokes 125, 130, 135 represent consecutive touching position changes of the stroke tool for one example of use of certain embodiments. The pan strokes PAN1 125, PAN2 135 may be used to move the position of a map in the direction indicated during each stroke, while the zoom stroke ZOOM 1 130 may be used to change the scale of the map without changing the map position, as is typical in conventional navigation systems. The pan strokes are shown as paths having a substantially constant direction, but it will be appreciated that the embodiments described herein are compatible with other stroke types, of which just one example is strokes that would be classified as right and left circular (or rotational) strokes. Also, the zoom stroke is shown as a nearly vertical stroke, so in this embodiment, the zooming effect of the image may be responsive to strokes that are generally (i.e., substantially) in one of an opposing first and second direction, i.e, up and down. It will be appreciated that the embodiments described herein are compatible with other zoom stroke types, of which just one example is strokes that would be classified as left and right strokes. However, there is no requirement that they be generally linear or opposing—they could be, for example, defined as circular strokes (i.e, clockwise to enlarge, counterclockwise to reduce), or at right angles.

Referring to FIG. 2, a functional block diagram showing some aspects of the electronic device 100 is shown, in accordance with certain embodiments. The electronic device 100 may include a processing system 205 and an input/output modality 210 that includes the touch screen 105. The processing system may comprise a processor that is controlled by programming instructions and data that are stored in one or more memories. The processor, programming instructions and data may be conventional, except that the arrangement and values used for at least a portion of the programming instructions and data are unique, thereby providing a pan control 215, a zoom control 220, and a mode control 225 that have unique aspects, as delineated further below.

The pan control 215 may accept touch position input during the pan mode and move the image on the display in directions responsive to those inputs. Similarly, the zoom control 220 may accept position input during the zoom mode and scales the image on the display in response to those inputs. (The zoom control 220 may resolve the touch position motion into one of two directions—up and down—and perform either a zoom in or zoom out in response to the resolved direction. In some embodiments, the zoom control 220 may resolve the touch position into one of four directions—up, down, right, left—and perform zooming for two of them and rotation for the other two) The pan and zoom control do not typically show the pan or zoom strokes 125, 130, 135 on the display of the touch screen 105. The mode control 225 may accept at least the touch pressure value inputs to determine a mode change event using either a tap module 230 or a pressure module 235. Both may not be present in all embodiments. The mode control 225 may further accept and rely upon position input to determine the mode change event. In response to a mode change event, the processing system 205 may change the mode of the touch screen 105 from pan mode to zoom mode, or vice versa.

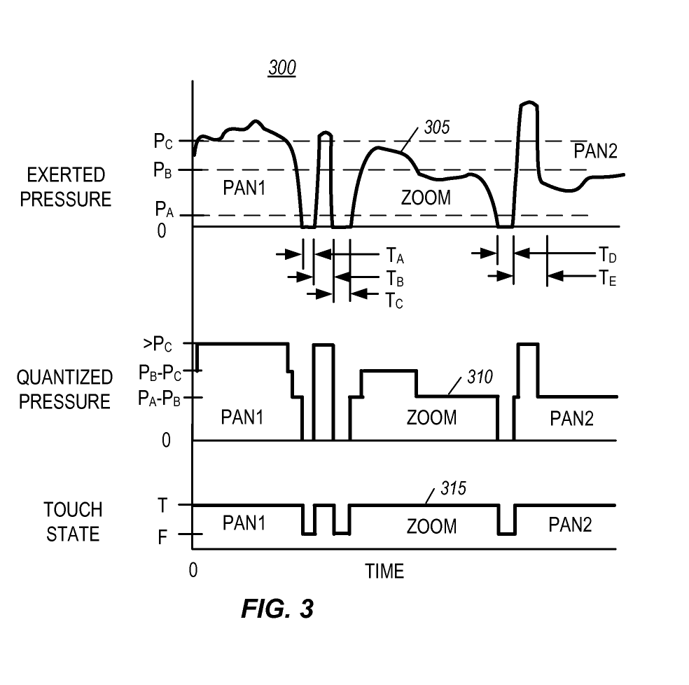

Referring to FIG. 3, time plots that are examples of certain characteristics of the strokes 125, 130, 135 (FIG. 1) are shown, in accordance with certain embodiments. Plot 305 is a plot of touch pressure that may have been exerted during the strokes 125, 130, 135. Plot 310 is a plot of quantized pressure values that may be generated by the touch screen 105 during the strokes, or which may be generated by a conversion performed by the mode control 225 of an “analog” input signal received from the touch screen 105 to a signal having a few quantized values. Plot 315 is a plot of a touch state signal that may be an output of the touch screen 105 or which, for example, may be determined by the processing system 205 in response to the presence or absence of position signals from the touch screen 105.

In accordance with two sets of embodiments, three exerted pressure levels, P_{A}, P_{B}, and P_{C}, are shown for plot 305. At time 0, the PAN1 stroke 125 is at or near the beginning of the stroke, and the touch pressure exerted (plot 305) is between P_{B} and P_{C}. Quantized touch pressure P_{B}-P_{C} (plot 310) may represent the exerted pressure during this time. The touch pressure then goes above a tap pressure threshold, P_{C}, and back down. At the end of PAN1 stroke 125, a drop in touch pressure is sensed. When the exerted touch pressure 305 goes to zero (i.e., the quantized touch pressure 310 is either received by the mode control 225 as an “analog” value near zero and is set to zero pressure, or is received from the touch screen 105 as a zero value) for a duration of T_{A}. Then the exerted touch pressure 305 goes above the tap pressure threshold, P_{C}, for a duration T_{B}, and the quantized touch pressure 310 is received as an analog value>P_{C} from the touch screen 105 and converted to a quantized value indicating>P_{C}, or is received from the touch screen 105 as a quantized value indicating>P_{C} during that duration. Then the exerted touch pressure drops again to zero, for a duration T_{C} and the quantized touch pressure is received or set at zero for that duration.

In accordance with a first example of embodiments, the mode control 225 senses the pressures, either as analog values or as quantized values, and senses the durations T_{A}, T_{B}, T_{C}, and compares them to a stored tap criterion, or profile. In this first example of tap embodiments, the pressure criterion is such that if T_{A} is below a maximum duration threshold (e.g., 125 milliseconds), and the pressure at all times during T_{B} exceeds P_{B}, and a trailing zero pressure level occurs having a duration T_{C} that is greater than a minimum duration threshold (e.g., 125 milliseconds), then a determination is made that a tap criterion has been met (i.e., a tap is sensed), and the mode control 225 changes from the pan mode to the zoom mode. In this first example of tap embodiments, the use of time durations allows a pressure level to be used that may be lower than pressures sensed while operating in one of the zoom or pan modes. In the second set of embodiments, the pressure criterion is such that if T_{D} is below a maximum duration threshold (e.g., 125 milliseconds), and the touch pressure at all times during T_{E} exceeds P_{C}, then a determination is made that a tap has occurred (i.e., a tap is detected), and the mode control 225 changes from the pan mode to the zoom mode. In accordance with the second set of embodiments, the tap criterion may be determined to have been met at the time when the touch pressure has dropped for duration T_{D}, then has risen for duration T_{E}. In a second example of embodiments, the tap pressure criterion uses a higher pressure level, P_{C}, than in the first example of embodiments. But it should be appreciated that an optimum pressure level needed to detect a tap will be related to the values of the durations and types of durations (i.e., whether one or both of a preceding and following duration are used in addition to the duration of the peak) for a particular embodiment, as determined by experimentation. Note that it would not be normal to have two embodiments, of which each are in one of the two just described sets of embodiments, both operating at the same time in an electronic device, since it would likely be confusing for many users. However, both of these embodiments are illustrated by FIG. 3 for brevity. If two such embodiments were available in one electronic device, then typically only one of them would be selected at a time, as a user preference. In these two sets of embodiments, it will be appreciated that the state of the touch input is irrelevant in determining a mode change between the pan and zoom mode, as can be observed from plots 305, 310, and 315, although the durations of touch input states could be used either as an alternative to durations of zero pressure, or could be required as redundant indication to durations of zero pressure. These variations would vary the benefits of the embodiments accordingly in terms of false indications and ease of use. Note that the use of touch states and duration information without touch pressure would not work very well in comparison to those embodiments that additionally or alternatively use the touch pressure information because there are many times when a user removes the strike tool for repositioning the tool for a new stroke, without wanting to change to zoom mode.

It will be appreciated that by using the sensed touch pressure of the stroke tool, the user does not have to move the tool to a button position shown on the touch screen 105, nor use a button or switch located elsewhere, thereby speeding up the time needed to make the move change; simplifying the complexity of making the mode change; and removing the need for a button or switch to make the mode change. The last cited benefit provides additional benefits of reducing area used on the touch screen 105 or other parts of the electronic device and in some cases, eliminating some moving parts.

There are many variations of the touch pressure and durations used for a tap criterion that could provide the same type of benefits described herein for other embodiments. These variations would occur to persons of ordinary skill in the art after reading this document. As just some examples, one of the leading durations (T_{A} and T_{D}) or the trailing duration (T_{C}), but not both, could be eliminated as a part of the criteria. Any of the durations may have one or both of a minimum and maximum value. The touch state could be substituted or added to a zero pressure detection requirement. In other variations, the touch pressure level required to meet the pressure criterion could be a threshold value of P_{B} instead of P_{C} for a minimum duration T_{M}. In these variations that use a tap criterion to determine a switch from a pan mode to a zoom mode, response to the touch position of the stroke tool during panning or zooming could be maintained at any value (including none) of touch pressure and touch position, until the tap criterion is met. Alternatively, there could be a requirement that touch pressure be maintained above zero (or a low pressure threshold such as P_{A}) for there to be a response to touch position. This may serve to improve the reliability of the detection of the stroke. In certain embodiments, the amount of touch pressure may be used as a criterion for a rate of image panning or a rate of zooming (depending on which mode the touch screen 105 is in). For example, there may two quantized pressure thresholds above zero that are used to produce one of two speeds of panning or zooming, or both, depending on the mode of the touch screen 105. Or, an analog pressure threshold may be used for such control. These embodiments may use pressure thresholds for rate control as well as a pressure threshold for tap detection. The criteria described above for tap detection are referred to herein as pressure criteria for tap detection, but as can be seen they may include a touch state requirement and or one or more durations. In many cases at least a minimum touch pressure threshold and two duration thresholds are included in the criterion—one duration for pressures above a minimum pressure threshold and another duration for a low or zero pressure threshold or a no-touch state. To state it a different way, pressure criterion for tap detection in these embodiments may include a tap pressure threshold associated with a first duration, and a second duration associated with one or both of a low pressure threshold and a no-touch state. The first and second durations may each have one or both of a minimum value and a maximum value, and the low pressure threshold may be zero.

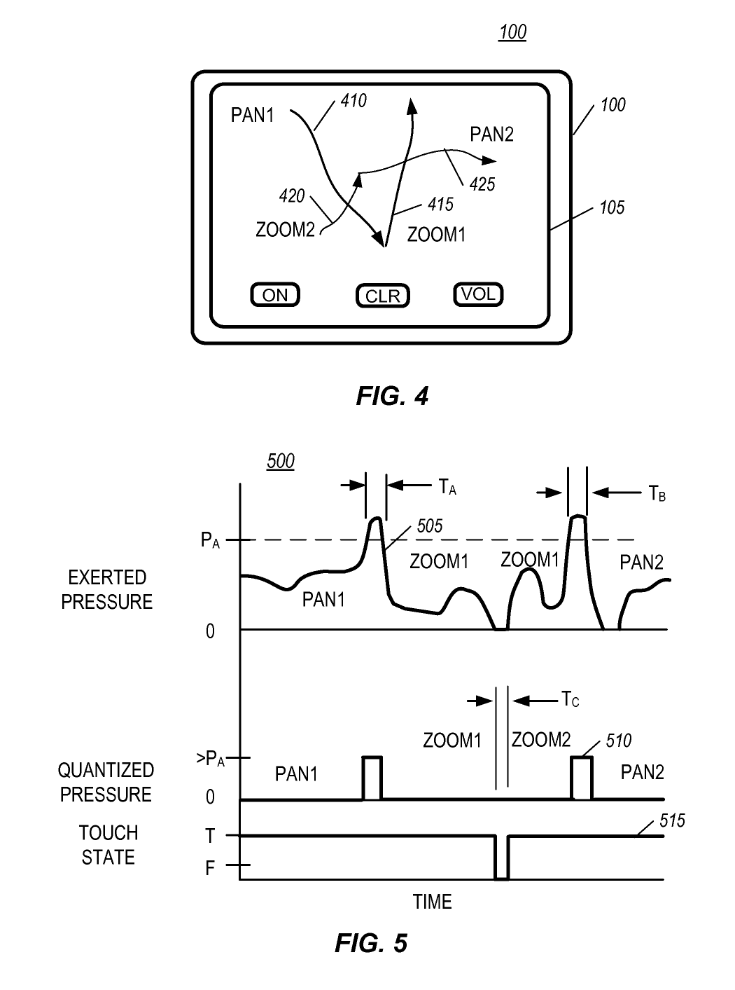

Referring now to FIG. 4, a diagram shows the electronic device 100, in accordance with certain embodiments. This diagram shows an example of four strokes 410, 415, 420, and 425 that are detected by the touch screen 105. In this example, a stroke PAN1 410 is in process in the pan mode at time 0 and continues while the exerted touch pressure is below P_{A}. During the PAN1 410 stroke, the image is panned down and to the right according to the touch position. At the end of the PAN1 stroke 410, a pressure criterion is met that changes the mode from pan to zoom. The next stroke, ZOOM1 stroke 415 is initiated at the point where PAN1 stroke 410 ended. The ZOOM1 stroke 415 ends when the stroke tool is removed from the touch screen 105 and moved to the start of a ZOOM2 stroke 420. In this example, the ZOOM1 stroke 415 is resolved as an up stroke that results in a zoom-in operation, and the ZOOM2 stroke 420 is also resolved as an up stroke that results in a continuation of the zoom-in operation. At the end of the ZOOM2 stroke 420, an input is detected that changes the mode of the touch screen 105 to pan, and the stroke motion of the stroke tool is then interpreted as a pan stroke, PAN2 425.

Referring to FIG. 5, time plots that are examples of certain characteristics of the strokes 410, 415, 420, 425 (FIG. 4) are shown, in accordance with certain embodiments. Plot 505 is a plot of touch pressure that may have been exerted during the strokes 410, 415, 420, 425. Plot 510 is a plot of quantized pressure values that may be generated by the touch screen 105 during the strokes, or which may be generated by a conversion performed by the mode control 225 of an “analog” input signal received from the touch screen 105 to a signal having a few quantized values. Plot 515 is a plot of a touch state signal that may be an output of the touch screen 105 or which, for example, may be determined by the processing system 205 in response to the presence or absence of position signals from the touch screen 105.

Two touch pressure levels, P_{A} and zero, are shown for plot 505. It will be appreciated that there may exist a second touch pressure level, or value, that is near but greater than zero, below which the quantized or measured touch pressure is approximated as zero. This would be similar to P_{A} for the exerted touch pressure plot 305 in FIG. 3. At time 0, the PAN1 stroke 410 is at or near the beginning of the stroke, and the exerted touch pressure (plot 505) is above zero and below touch pressure level P_{A}, which may be referred to as the tap pressure threshold. A quantized pressure threshold of zero (plot 510) may represent the exerted touch pressure during this time. At the end of PAN1 stroke 410, an increase in pressure above touch pressure tap threshold P_{A} is sensed for a duration T_{A}. In this example, the stroke tool is not removed from the touch screen 105, so the touch state remains at T. The mode control 225 senses the pressure values, either as analog values or as quantized values, and senses the duration T_{A} and compares them to a stored pressure criterion, or profile. In some embodiments, the pressure criterion is such that if T_{A} is above a minimum threshold (e.g., 200 milliseconds), and the touch pressure during T_{A} continually exceeds P_{A}, then a determination is made that a pressure criterion has been met, and the mode control 225 changes from the pan mode to the zoom mode. In accordance with this example, the pressure criterion may again be met at the time when the touch pressure again rises above P_{A} for duration T_{B}. In these embodiments, it will be appreciated that the state of the touch input is irrelevant in causing a mode change between the pan and zoom mode, as can be observed from plots 505, 510, and 515. In some embodiments, wherein the touch screen 105 is designed such that false detections of touch pressures above the threshold P_{C} do not occur very often, a requirement for a minimum duration for T_{A}, T_{B} may not be needed.

It will be appreciated that the embodiments described with reference to FIG. 5 provide similar benefits as those described above with reference to FIG. 3, and that there are variations of the touch pressures and durations that could provide the same type of benefits described herein for other embodiments. These variations would occur to persons of ordinary skill in the art after reading this document. The criteria described above with reference to FIG. 5 are also referred to herein as pressure criteria for tap detection. At least a minimum pressure threshold is included in the pressure criterion and in some embodiments a duration for the minimum pressure threshold is used. To state it a different way, pressure criterion for tap detection in these embodiments may include a minimum pressure threshold, which may be associated with a first duration. The first duration may have one or both of a minimum value and a maximum value. It will be appreciated that at least when a duration is not used as part of the criterion for detecting a tap, the pressure threshold for detecting a tap is a value above which zooming and panning are not performed.

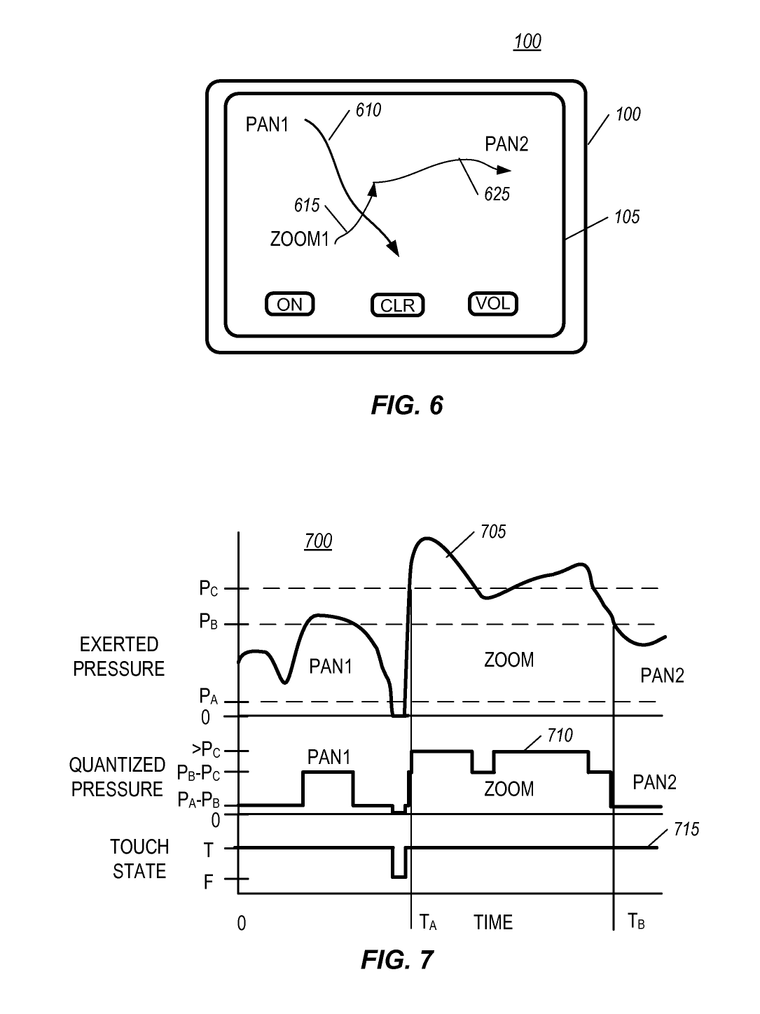

Referring now to FIG. 6, a diagram shows the electronic device 100, in accordance with certain embodiments. This diagram shows an example of three strokes 605, 610, and 615 that are detected by the touch screen 105. In this example, a stroke PAN1 610 is in process in the pan mode at time 0 and continues while the exerted touch pressure is below P_{C}. During the PAN1 610 stroke, the image is panned down and to the right according to the touch position. At the end of the PAN1 stroke 610, a first touch pressure criterion is met that changes the mode from pan to zoom. The stroke tool is lifted from the face of the touch screen 105 and a next stroke, ZOOM1 stroke 615 is initiated at a new position. The ZOOM1 stroke 615 ends when a second touch pressure criterion is met. In this instance, the stroke tool is not removed from the face of the touch screen 105, and a PAN2 stroke 625 is executed. In this example, the ZOOM1 stroke 615 is resolved as an up stroke that results in a zoom-in operation.

Referring to FIG. 7, time plots that are examples of certain characteristics of the strokes 610, 615, 620 (FIG. 6) are shown, in accordance with certain embodiments. Plot 705 is a plot of touch pressure that may have been exerted during the strokes 610, 615, 620. Plot 710 is a plot of quantized pressure values that may be generated by the touch screen 105 during the strokes, or which may be generated by a conversion performed by the mode control 225 of an “analog” input signal received from the touch screen 105 to a signal having a few quantized values. Plot 715 is a plot of a touch state signal that may be an output of the touch screen 105 or which, for example, may be determined by the processing system 205 in response to the presence or absence of position signals from the touch screen 105.

Four touch pressure thresholds, P_{A}, P_{B}, P_{C} and zero, are shown for plot 505. At time 0, the PAN1 stroke 610 is at or near the beginning of the stroke, and the exerted touch pressure (plot 705) is above P_{A} and below touch pressure level P_{B}. A quantized pressure value of P_{A}-P_{B} (plot 710) may represent the exerted touch pressure during this time. At the end of PAN1 stroke 610, a decrease of touch pressure to zero may be sensed when the stroke tool is lifted, then an increase in touch pressure above pressure level P_{C} is sensed at time T_{A}. The mode control 225 senses the pressure values, either as analog values or as quantized values, and compares them to a stored pressure criterion, or profile. In these embodiments, when the mode is a pan mode and the touch pressure increases to become greater than a zoom pressure threshold P_{C}, then a determination is made that a first pressure criterion has been met, and the mode control 225 changes from the pan mode to the zoom mode. In accordance with this example, a second pressure criterion is that when the mode is the zoom mode and the touch pressure is sensed to fall below pan pressure threshold P_{B}, then the mode is changed from zoom to pan. In these embodiments, it will be appreciated that the state of the touch input and drops of pressure below P_{A} are irrelevant in causing a mode change between the pan and zoom mode, or vice versa, as can be observed from plots 705, 710, and 715.

It will be appreciated that these embodiments provide similar benefits as those described above with reference to FIG. 3, and that, as for the embodiments described above with reference to FIG. 3, there are variations of the touch pressure and durations that could provide the same type of benefits described herein for other embodiments. These variations would occur to persons of ordinary skill in the art after reading this document. For example, a minimum duration for which the touch pressure exceeds P_{C} may be required before changing from the pan mode to the zoom mode, and a similar minimum duration relative to the touch pressure going below P_{B} may be required to change from the zoom mode to the pan mode. In some variations, the touch pressure thresholds P_{B} and P_{C} may have the same value, especially when a duration threshold (a maximum duration or a minimum duration) is used. The criteria described above for pressure detection with reference to FIG. 7 are referred to herein as pressure criteria. At least one pressure threshold is included in the pressure criterion for pressure detection and in some embodiments a minimum duration after crossing a pressure threshold is included (two pressure thresholds may be used in some embodiments, as described above, as well as durations associated with each). To state it a different way, pressure criteria for pressure detection in these embodiments may include at least a first pressure threshold, which may be associated with a respective minimum duration. It will be appreciated that in some embodiments, it may be difficult to distinguish whether the embodiment is a tap detection or pressure detection embodiment. Such distinction is not a significant aspect of the embodiments.

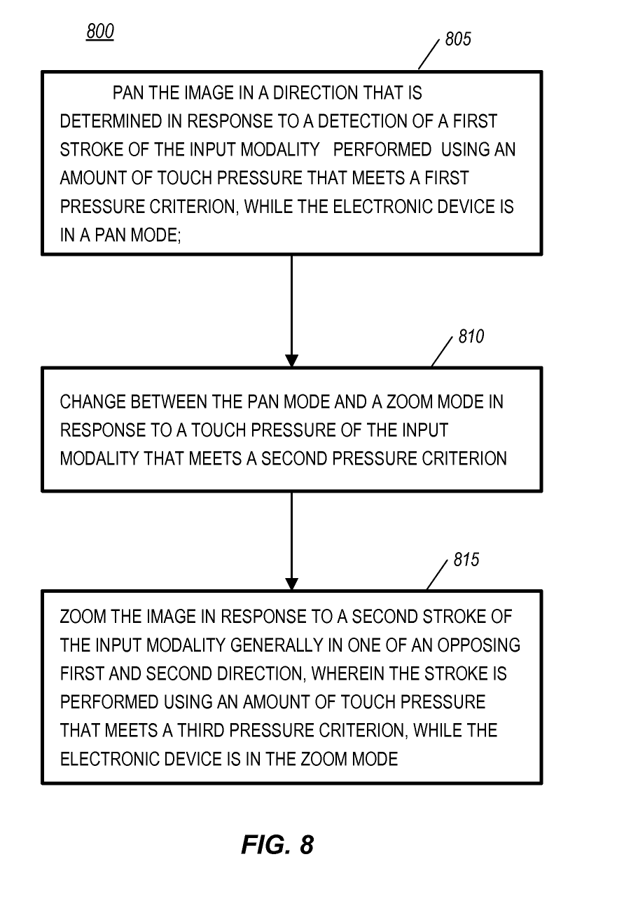

Referring to FIG. 8, a flow chart 800 shows some steps of a method for manipulating an image displayed on a display of an electronic device 100, in accordance with certain embodiments. The electronic device 100 has a touch sensitive input modality that has a capability of sensing touch position and touch pressure. At step 805, an image is panned in a direction that is determined in response to a detection of a first stroke of the input modality (i.e., a first stroke of the surface of the input modality). The panning is performed while the stroke is being made using an amount of touch pressure that meets a first pressure criterion and the electronic device is in a pan mode. At step 810, the pan mode is changed to a zoom mode in response to a touch pressure of the input modality that meets a second pressure criterion. At step 815, the image is zoomed in response to a second stroke of the input modality. The stroke is generally in one of an opposing first and second direction. The zooming is performed while the stroke is being made using an amount of touch pressure that meets a third pressure criterion and the electronic device is in the zoom mode.

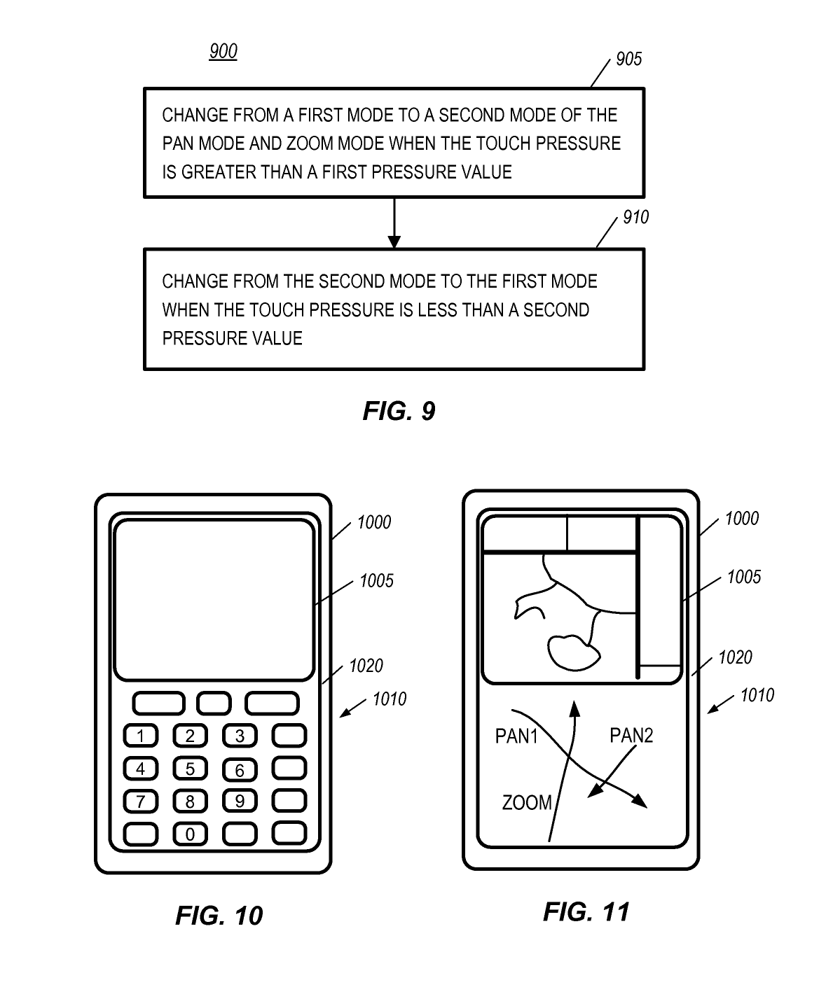

Referring to FIG. 9, a flow chart 900 shows some steps of a method for changing from a pan mode to a zoom mode in accordance with certain embodiments. The method is related to the pressure detection method. At step 905, a change from a first mode to a second mode of the pan and zoom modes is made when the touch pressure is greater than a first pressure threshold. A first minimum duration may be required before the mode is changed from the first mode to the second mode. At step 910, a change from the second mode to the first mode of the pan and zoom modes is made when the touch pressure is less than a second pressure threshold. A second minimum duration may be required before the mode is changed from the second mode to the first mode. The first and second minimum durations may be equal. The first and second pressure thresholds may be equal.

Referring to FIGS. 10 and 11, diagrams show two views of an electronic device 1000, in accordance with certain embodiments. The electronic device 1000 has a display area 1005 and an input area 1010. The electronic device 1000 is representative of at least two physically different types of devices (which do not correlate to the differences of the two views shown in FIGS. 10 and 11). In some embodiments, the display area 1005 is a display device that does not act as an input device—for example, it is not touch sensitive. In these embodiments, the input area 1010 is a soft defined input area responsive to touch input. That is to say, it has a display and touch sensing. The display hardware for the input area 1010 may be different than that of the display area 1005. For example, the pixel density in the input area 1010 may be lower and may be black and white or gray scale, while the display area 1005 may have a higher pixel density and may be a full color display. In other embodiments, the entire region 1020 may comprise a display that has high pixel density and is color throughout, and which has touch sensitivity at least in the input region 1010. In all of theses embodiments, the input area may morph for different modes of operation of the electronic device 1000. This aspect is illustrated by the differences between FIGS. 10 and 11. In FIG. 10, the input is arranged as a keyboard that is responsive to touch buttons having a variety of functions (only the number keys are labeled, for simplicity). The display area 1005 in this mode of operation could be used for standard phone functions, such as showing a list of contacts. In FIG. 11, the input area 1010 may appear to the user as being blank, or there could be a few active buttons provided (as described above with reference to FIG. 1). FIG. 11 shows a blank input area 1010 superimposed with stroke paths that would typically not be displayed in a mode such as a map mode (although such a feature could be provided if it were deemed beneficial in some mode). The input area 1010 in these embodiments could be responsive to touch in the same manner as described above with reference to FIGS. 1-9.

It will be appreciated, that when objects within the image region of the input/output modality 105 are active, which for the purposes of this document will all be referred to as active objects, then the touch position at which a criterion for change from pan to zoom (or vice versa) would otherwise be met is not met if the position is within the active object. In other words, the touch position at which the pressure criterion for a pan to zoom change (or for a zoom to pan change) is met is exclusive of any active objects within the image region.

It will be appreciated that embodiments of the invention described herein may be comprised of one or more conventional processors and unique stored program instructions that control the one or more processors to implement, in conjunction with certain non-processor circuits, some, most, or all of the functions described herein. The non-processor circuits may include, but are not limited to, a radio receiver, a radio transmitter, signal drivers, clock circuits, power source circuits, and user input devices. As such, these functions may be interpreted as steps of a method for manipulating an image displayed on a display of an electronic device using a touch sensitive input modality that has a capability of sensing touch position and touch pressure. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

1. A method for manipulating an image displayed on a display of an electronic device using a touch sensitive input modality that has a capability of sensing touch position and touch pressure, comprising:
panning the image in a direction that is determined in response to a detection of a first stroke of the input modality performed using an amount of touch pressure that meets a first pressure criterion, while the electronic device is in a pan mode;
changing between the pan mode and a zoom mode in response to a touch pressure of the input modality that meets a second pressure criterion; and
zooming the image in response to a second stroke of the input modality, wherein the stroke is performed using an amount of touch pressure that meets a third pressure criterion, while the electronic device is in the zoom mode.

2. The electronic device according to claim 1, wherein the touch position at which the second pressure criterion is met is exclusive of any active objects within the image region.

3. The method according to claim 1, wherein in the panning of the image, a rate of the panning of the image is responsive to a fourth criterion based on touch pressure.

4. The method according to claim 1, wherein in the zooming of the image, a rate of the zooming of the image is responsive to a fifth criterion based on touch pressure.

5. The method according to claim 1, wherein the first and third pressure criteria correspond, respectively, to a first pressure threshold and a second pressure threshold, and wherein the changing between the pan mode and zoom mode further comprises:
changing from the pan mode to the zoom mode when the touch pressure is greater than the first pressure threshold; and
changing from the zoom mode to the pan mode when the touch pressure is less than the second pressure threshold.

6. The method according to claim 1, wherein the second pressure criterion is a tap criterion that comprises a tap pressure threshold.

7. The method according to claim 6, wherein the second pressure criterion includes a maximum duration for which the touch pressure must exceed the tap pressure threshold.

8. The method according to claim 6, wherein the second pressure criterion includes at least one of a minimum and maximum duration for which the touch pressure is one or both of a) below a low pressure threshold and b) in a no-touch state.

9. The method according to claim 6, wherein the first pressure criterion and third pressure criterion comprise pressure thresholds that are both less than the touch pressure tap threshold.

10. The method according to claim 1, wherein the input modality senses touch position using one of optical, capacitive, and resistive techniques, and the input modality senses touch pressure using one of force sensing resistive and strain gauge techniques.

11. An electronic device, comprising:
an input-output modality that comprises
a display that displays an image, and
a touch input modality that has a capability of sensing a touch position and a touch pressure; and
a processing system for manipulating the image in response to the touch position and pressure, comprising
a pan control function that pans the image in a direction that is determined in response to a detection of a first stroke of the input modality performed using an amount of touch pressure that meets a first pressure criterion, while the electronic device is in a pan mode,
a mode control function that changes an input mode between the pan mode and a zoom mode in response to a touch pressure of the touch input modality that meets a second pressure criterion and
a zoom control function that zooms the image in response to a second stroke of the input modality generally in one of an opposing first and second direction, wherein the stroke is performed using an amount of touch pressure that meets a third pressure criterion, while the electronic device is in the zoom mode.

12. The electronic device according to claim 11, wherein the touch position at which the second pressure criterion is met is exclusive of any active objects within the image region.

13. The electronic device according to claim 11, wherein in the panning of the image, a rate of the panning of the image is responsive to a fourth criterion based on touch pressure.

14. The electronic device according to claim 11, wherein in the zooming of the image, a rate of the zooming of the image is responsive to a fifth criterion based on touch pressure.

15. The electronic device according to claim 11, wherein the first and third pressure criteria correspond, respectively, to a first pressure threshold and a second pressure threshold, and wherein the changing between the pan and zoom mode further comprises:
changing from the pan mode to the zoom mode when the touch pressure is greater than the first pressure threshold; and
changing from the zoom mode to the pan mode when the touch pressure is less than the second pressure threshold.

16. The electronic device according to claim 11, wherein the second pressure criterion is a tap criterion that comprises a tap pressure threshold.

17. The electronic device according to claim 11, wherein the input modality senses touch position using one of optical, capacitive, and resistive techniques, and the input modality senses touch pressure using one of force sensing resistive and strain gauge techniques.
